(19) United States
(12) Patent Application Publication
(10) Pub. No.: US 2008/0020819 A1
(43) Pub. Date: Jan. 24, 2008

(54) GAMING MACHINE, GAMING SYSTEM, AND GAME CONTROL METHOD

(75) Inventor: Hiro Sakuma, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: ARUZE CORP., Koto-ku (JP)

(21) Appl. No.: 11/777,574

(22) Filed: Jul. 13, 2007

(30) Foreign Application Priority Data
Jul. 24, 2006 (JP) 2006-200628

(51) Int. Cl. A63F 13/00; A63F 9/24; G06F 17/00

(52) U.S. Cl. 463/20

(57) ABSTRACT

A gaming machine comprises: a selection switch capable of entering an input for selecting one out of a plurality of kinds of special games to be played a predetermined number of times without making any bet; and a processor unit for executing a determination process for determining a multiplication factor at a time of winning the one kind of special game and a number of special games to be played in the one kind of special game based on received data of a selection situation that the one kind of special game is selected with other gaming machines when an instruction signal to select the one special game is detected from the selection switch.

### CROSS REFERENCE TO RELATED APPLICATIONS

This application is based upon and claims the benefits of priority from Japanese Patent Application No. 2006-200628 filed on Jul. 24, 2006, the entire contents of which are incorporated herein by reference.

### FIELD OF THE INVENTION

The present invention relates to a gaming system comprising a management server and a gaming machine such as a slot machine in which a game is performed using a game medium such as coin and a method of controlling the game with the gaming system.

### RELATED ART

Conventionally, a gaming machine such as a slot machine is provided with a free game that is performed a predetermined number of times without betting a game medium if a predetermined condition is satisfied. An example gaming machine thereof determines the number of times of such free games to be performed and a multiplication factor applied to a reward amount of winning in the free game each time just before starting the free game so as to provide a new amusement characteristic of the game.

There is a conventional gaming machine of an amusement characteristic in which a probability to select a special game is increased as the number of times when the predetermined winning combination of symbols is stopped and displayed is increased (e.g., Japanese Unexamined Patent Application Publication No. 2004-215988). Also, there is a gaming machine in which, in a base game, the winning probability is set higher if the number of bets is more whereas the winning probability in the special game is set higher if the number of bets is less (e.g., Japanese Unexamined Patent Application Publication No. 2005-218620).

In the gaming machine disclosed in Japanese Unexamined Patent Application Publication No. 2004-215988, a game player can influence the game by operating the gaming machine to cause the predetermined winning combination of symbols to stop and appear oven and over again since the probability to select the special game can be influenced. Also, in the gaming machine disclosed in Japanese Unexamined Patent Application Publication No. 2005-218620, the game player can influence the game since the game player can change the bet number depending on the game condition.

### SUMMARY OF THE INVENTION

In the present invention, a gaming machine, a gaming system, and a game control method in which a plurality of kinds of special games are provided and the game player can select one of the plurality of kinds of special games are provided. A new type of entertainment that has not been provided to the conventional gaming machine can be added to the gaming machine of the present invention. The selection bias is prevented when the player selects one of the plurality of kinds of special games while each gaming machine can have an own individual characteristic.

The gaming machine comprises: a selection switch capable of entering an input for selecting one out of a plurality of kinds of special games to be played a predetermined number of times without making any bet; and a processor unit for executing a determination process for determining a multiplication factor at a time of winning the one kind of special game and a number of special games to be played in the one kind of special game based on received data of a selection situation that the one kind of special game is selected in other gaming machines when an instruction signal to select the one special game is detected from the selection switch.

The gaming system comprises: a management server and a plurality of gaming machines in which a plurality of kinds of special games can be played a predetermined number of times without making any bet. The management server executes a process for calculating a number of special games to be played in one kind of special game and a multiplication factor at a time of winning the one kind of special game. Each of the plurality of gaming machines executes a process for determining a number of special games to be played in the one kind of special game and a multiplication factor at a time of winning the one kind of special game based on a calculation result of the management server.

Further features of the present invention, its nature, and various advantages will be more apparent from the accompanying drawings and the following description of the preferred embodiment.

### BRIEF DESCRIPTION OF THE DRAWINGS

FIG. 1 is a schematic view showing a whole configuration of a gaming system according to an embodiment of the present invention.

FIG. 2 is a perspective view showing a gaming machine schematically according to an embodiment of the present invention.

FIG. 3 is a schematic diagram showing symbol columns drawn on an outer circumferential face of each reel.

FIG. 4 is a block diagram showing an internal configuration of the gaming machine as shown in FIG. 2.

FIG. 5 is a block diagram showing an internal configuration of a control device according to an embodiment of the present invention.

FIGS. 6A and 6B are drawings showing data for free game selection.

FIG. 7 illustrates a flowchart showing a subroutine of a free game selection process.

FIG. 8 is a drawing showing an example image displayed on a lower image display panel when the free game selection process is conducted.

FIG. 9 illustrates a flowchart showing a subroutine of a game execution process.

FIG. 10 illustrates a flowchart showing a subroutine of a lottery process.

FIG. 11 is a drawing illustrating a relationship between a winning probability and a payout number of each winning combination among a plurality of kinds of winning combinations according to the present embodiment.

FIG. 12 illustrates a flowchart showing a subroutine of a free game process.

FIG. 13 illustrates a flowchart showing a calculation process conducted between a gaming machine and a management server.

FIG. 14 illustrates a graph based on a simulation result according to the embodiment of the present invention.

### DETAILED DESCRIPTION OF THE PREFERRED EMBODIMENT

In the following detailed description, major characteristic parts are mainly described for easier understanding of the present invention. The present invention, however, is not limited to the embodiment described in the following detailed description and it may also be applied to other embodiment so as to cover a variety of area. Terms and expressions used in the present specification are used to explain the present invention in an appropriate manner, but are not used to limit the construction of the present invention. It should be understood that the one skilled in the art may easily make modification and alteration to form other configurations, systems, methods, and so on, which are within the scope of the present invention, from the concept of the present invention written in the present specification. Therefore, it is understood that the embodiment shown in the drawings and description is merely for illustrative purposes and not intended to limit the scope of the invention, which is defined by the following claims as interpreted according to the principles of patent law, including the Doctrine of Equivalent.

Further, the purpose of the abstract is to enable the United States Patent and Trademark Office and the public generally to determine quickly from a cursory inspection the nature and gist of the technical disclosure. Therefore, the abstract does not limit the scope of the invention which should be evaluated by the claims. The abstract should not refer to purported merits or speculative applications of the invention and should not compare the invention with the prior art. It is desirable to refer to the references having been disclosed so as to understand an objective and specific effects of the present invention.

In the following detailed description, processes will be explained as being included in a case where such processes are executed on a computer or a computer network. The following description and expressions are described for the purpose that one skilled in the art may most efficiently understand the invention.

In the present specification, each step utilized to lead a result should be understood as a self-consistent process. In each step, the transmission and reception, recordation or the like of electric or magnetic signals may be performed. In processing in each step, although such signals are expressed in a bit, value, symbol, character, term, numeral, and the like, it should be noted that these expressions are used only for convenience of explanation. Further, the processing in each step may be described with expressions common to human behavior, but the processing described in the present specification is basically executed by various kinds of devices. Other configurations desired for performing each step become obvious from the following description.

### [Definition of Terms and the Like]

As mentioned before, the bonus game, free game, and special game may be used in an interexchangeable manner. However, the special game may be used in the present specification by way of example.

The “special game” means a game different from an base game and means a game which can be played a predetermined number of times without making any bet. Therefore, if the prescribed conditions are satisfied during the performance of the base game, the special game starts. Then, the base game is resumed after the special game is completed. In the present invention, a plurality of kinds of special games exist.

The “selection switch” is a switch for inputting an instruction for selecting one kind of special game out of the plurality of kinds of special games. When the game player operates this switch, a command signal for selecting one of the special games is output. Thereby, it is detected that one of the special games is selected.

The “selection situation of the special games in other gaming machines” means how many gaming machines select each of the special games. Hereinafter, a method of “determining a multiplication factor at the time of winning each of the special games” in accordance with “selection situation of the special games in other gaming machines” is explained.

Embodiments of the present invention are described in reference to the attached drawings. In the present specification, a “bonus game”, a “free game”, and a “special game” may be used in an interexchangeable manner. However, the “special game” may be used as a more general term and the “free game” is used to explain the embodiment in the following description.

First, a gaming system according to the present invention is described.

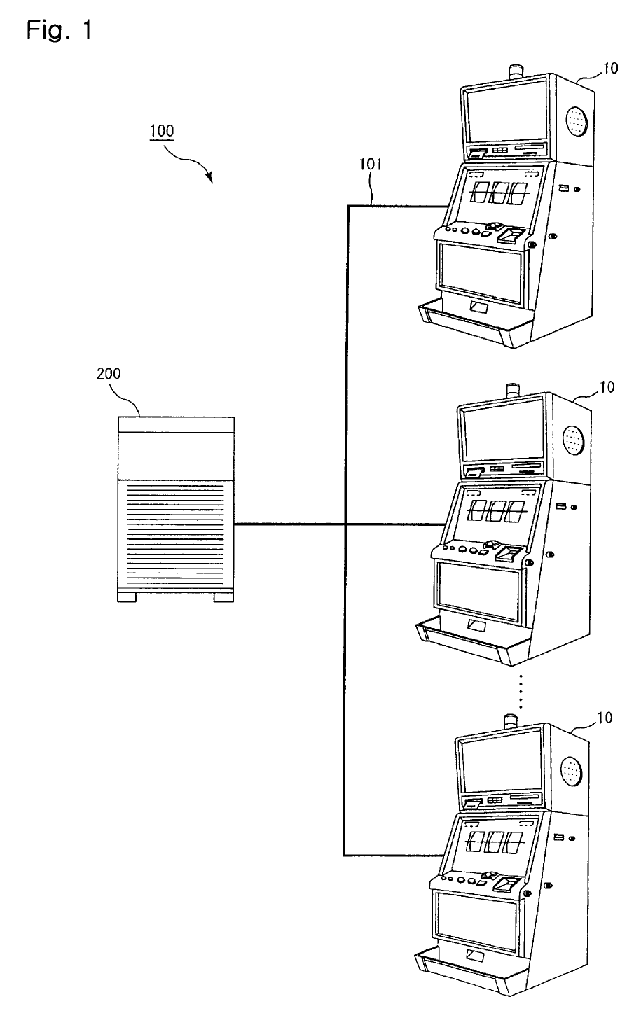

FIG. 1 is a schematic diagram showing the entire configuration of the gaming system according to an embodiment of the present invention. A gaming system 100 comprises: a plurality of gaming machines 10 and a management server 200 connected with these gaming machines 10 via prescribed communication lines 101. The gaming system 100 of this kind may be constructed in a game hall (e.g., a bar and a casino) in which various games can be played and may be constructed in a plurality of game halls. The gaming system 100 may be constructed for each floor or section of the game hall when being constructed in the one game hall. The communication lines 101 are not limited hereto in particular, but they may be wired and/or wireless. A dedicated line, a switched line, or the like can be adopted for the communication lines 101.

The gaming machine 10 receives a selection instruction input for one kind of free game via a selection switch when a game is started. The selection switch may be a touch panel provided on the screen of the gaming machine 10, or a dedicated switch may be provided. Also, a spin button, a change button, a cash-out button, a BET button, or the like may function as the selection switch.

The management server 200 receives information concerning the kind of the selected free game from each gaming machine 10. Timing for receiving the information concerning the kind of the selected free game is not limited hereto in particular, but it is desirable to be immediately after the operation of the selection switch.

Further, upon receiving the information concerning the kind of the selected free game, the management server 200 calculates and changes the number of free games of the kind to be played which are indicated by the information, or another kind of free game than the free game of the kind indicated by the information. That is, when the information concerning the kind of the selected free game is received, for example, the number of free games of the one kind to be played may be increased or decreased. Or the number of free games of the other kinds to be played may be increased or decreased. Or the number of free games of all kinds to be played may be increased or decreased.

In the present invention, it is desirable to decrease the number of free games of the one kind to be played as the number of gaming machines 10 in which the one kind of free game is selected increases.

Further, upon receiving the information concerning the kind of the selected free game, the management server 200 changes a multiplication factor at the time of winning the free game of the same kind indicated by the information, or a free game of another kind than the free game of the kind indicated by the information. That is, when the information concerning the kind of the selected free game is received, for example, the multiplication factor at the time of winning the free game may be changed, the multiplication factor at the time of winning all free games other than the one free game may be changed, or the multiplication factor at the time of winning both free games may be changed.

In the present invention, it is preferable to reduce the multiplication factor at the time of winning in the free game as the number of gaming machines 10 in which the one free game is selected increases.

In the gaming machine 10, the number of free games of one kind to be played which is selected by means of the selection switch and the multiplication factor at the time of winning the free game are determined according to the selection situation of the free game in other gaming machines 10 connected to the management server 200. A method of determining the number of free games of the one kind to be played which is selected by means of the selection switch and the multiplication factor at the time of winning the free game is not limited hereto in particular. For example, data for free game selection including the number of free games of the kind to be played and the multiplication factor at the time of winning each free game is received from the management server 200, and the number of free games of the one kind to be played which is selected by means of the selection switch and the multiplication factor at the time of winning the free game are determined based on this data for the free game selection.

Referring to another example, upon receiving the information concerning the kind of the selected free game from each gaming machine 10, the management server 200 transmits this information to each gaming machine 10. In this case, when the information concerning the kind of the selected free game is received successively, in each gaming machine 10, the number of free games of each kind to be played and the multiplication factor at the time of winning each free game are calculated based on this information. Then, the number of free games of the kind to be played which is selected by means of the selection switch and the multiplication factor at the time of winning the free game are determined based on the calculated results.

The method of calculating the number of free games of the kind to be played and the multiplication factor at the time of winning the free game is not limited hereto in particular. For example, a calculation method using prescribed formulae based on the number of gaming machines 10 in which each kind of free game is selected may be provided.

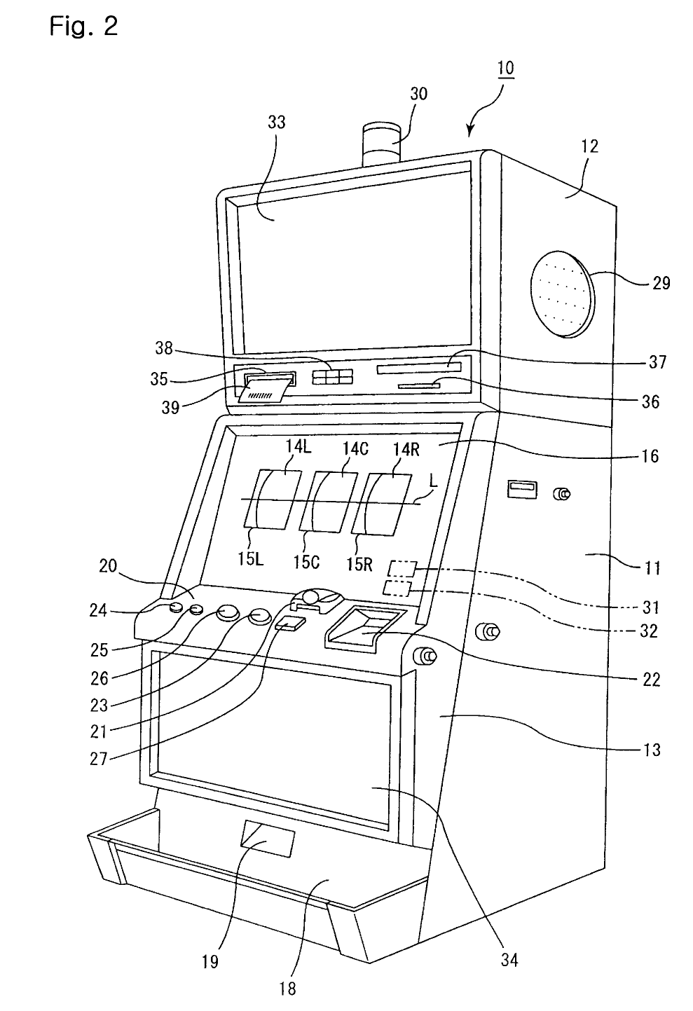

FIG. 2 is a perspective view schematically showing a gaming machine according to an embodiment of the present invention.

In this embodiment, the gaming machine 10 is a slot machine. However, in the present invention, the gaming machine is not limited to the slot machine, and may be, for example, a so-called single gaming machine such as a video slot machine and a video card gaming machine. Further, the gaming machine may be a so-called mass gaming machine (multiple-terminal gaming machine) such as a horse race game, a bingo game, and a public lottery for playing a game which needs a predetermined period of time before a result of the game is displayed as a horse race game, a bingo game, a public lottery, or the like.

In the gaming machine 10, a coin, a bill, and/or electronic valuable information corresponding to the coin or the bill is used as a game medium. However, in the present invention, the game medium is not particularly limited thereto, and a medal, a token, electronic money, and a ticket, for example, can be included. Further, the aforementioned ticket is not particularly restrictive such that a ticket with a bar code to be described later may be included, for example.

The gaming machine 10 comprises a cabinet 11, a top box 12 placed on the top of the cabinet 11, and a main door 13 provided on the front of the cabinet 11. Three reels 14 (14L, 14C, and 14R) are rotatably provided inside the cabinet 11. An array of symbols comprising twenty two (22) symbols is drawn on the outer circumferential surface of each reel 14.

A lower image display panel 16 is provided in front of each reel 14 in the main door 13. The lower image display panel 16 is provided with a transparent liquid crystal panel and various kinds of information, production images, and the like concerning a game are displayed during the game.

A credit number display part 31 and a payout number display part 32 are set in the lower image display panel 16. The number of credited coins is displayed on the credit number display part 31 with an image. The number of coins to be paid out is displayed on a pay out display part 32 with an image when a combination of symbols stopped and displayed on a pay line L matches a predetermined combination.

Three display windows 15 (15L, 15C, and 15R) through which the backside can be recognized visually are formed on the lower image display panel 16, and three symbols drawn on the outer circumferential surface of each reel 14 are displayed via each display window 15. One pay line L which passes horizontally across the three display windows 15 is formed on the lower image display panel 16. The pay line L specifies a combination of symbols. When a combination of symbols stopped and displayed along the pay line L matches the predetermined combination, a corresponding number of coins to the combination and the number of inserted coins (BET number) are paid out.

Alternatively, in the present invention, for example, a plurality of pay lines L may be formed passing horizontally or obliquely across the three display windows 15. In this case, when a corresponding number of pay lines L to the number of inserted coins are activated and a combination of symbols stopped and displayed along the activated pay lines L matches the predetermined combination, the corresponding number of coins to the combination may be paid out.

Although not illustrated, a touch panel 69 is provided on the front face of the lower image display panel 16 and a game player can input various kinds of instructions by operating the touch panel 69.

A control panel 20 comprising a plurality of buttons 23 to 27 through which instructions about a game progress are input by the game player, a coin receiving opening 21 for receiving coins into the cabinet 11, and a bill validator 22 are provided below the lower part of the lower image display panel 16.

The spin button 23, the change button 24, the CASHOUT button 25, the 1-BET button 26, and the MAX BET button 27 are provided on the control panel 20. The spin button 23 is provided for inputting an instruction for starting to rotate the reel 14. The change button 24 is utilized when an attendant of the game hall is called for money exchange. The CASHOUT button 25 is utilized for inputting an instruction for paying out the credited coins to a coin tray 18.

The 1-BET button 26 is utilized for inputting an instruction for betting one coin on the game which is brought from the credited coins. The MAX BET button 27 is used for inputting an instruction for betting on the game the maximum number of coins (50 coins in the present embodiment) which can be bet on one game. The maximum number of coins are taken from the credited coins.

In the present invention, the insertion of the game medium means that the game medium is bet on the game. For example, when coins inserted into the coin receiving opening 21 are directly bet on the game, the insertion of coins into the coin receiving opening 21 corresponds to the insertion of the game media. However, as in the present embodiment, when coins are inserted into the coin receiving opening 21, the coins are deposited as a credit. When the 1-BET button 26 or the MAX BET button 27 is operated, the corresponding number of credited coins are bet on the game. Therefore, that the credited coins are bet on the game corresponds to the insertion of the game media.

The bill validator 22 checks the suitability of the bill so as to receive only the authentic bill into the cabinet 11. The bill validator 22 may be configured to be able to read a ticket with a bar code 39 to be described later. A belly glass 34 on which the characters of the gaming machine 10 and the like are drawn is provided on the front of the lower part of the main door 13, that is, below the control panel 20.

An upper image display panel 33 is provided on the front face of the top box 12. The upper image display panel 33 comprises a liquid crystal panel and displays, for example, images for illustrating the contents of the game and the description of the rules of the game.

A speaker 29 is provided to the top box 12. A ticket printer 35, a card reader 36, a data indicator 37, and a keypad 38 are provided on a lower portion of the upper image display panel 33. The ticket printer 35 prints on a ticket a bar code on which data about the amount of credits, date and time, the identification number of the gaming machine 10, and the like are coded, and spits out the ticket with the bar code 39. The game player can cause another gaming machine to read the ticket with the bar code 39 to play a game with the other gaming machine, or convert the ticket with the bar code 39 into bills and the like in a prescribed place of the game hall (for example, a cashier booth in a casino).

The card reader 36 reads data from a smart card and writes data on the smart card. The smart card is a card held by the game player, and data for identifying the game player and data concerning the history of games played by the game player are stored, for example. Data corresponding to coins, bills, or credits may be stored in the smart card. Further, a magnetic stripe card may be adopted instead of the smart card. The data indicator 37 comprises a fluorescent display and the like, and displays the data read by the card reader 36, and data input by the game player via the keypad 38, for example. The keypad 38 is used for inputting instructions and data concerning ticket issuance and the like.

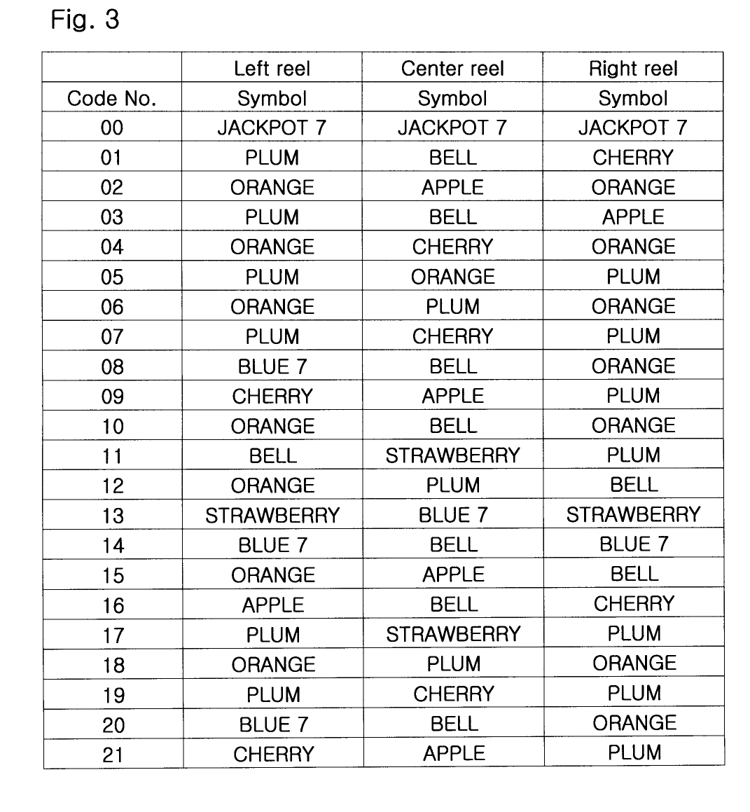

FIG. 3 is a pattern diagram showing an array of symbols drawn on the outer circumferential surface of each reel.

Twenty two (22) symbols are drawn on the outer circumferential surface of the left reel 14L, the middle reel 14C, and the right reel 14R, respectively. The array of symbols drawn on each reel 14 differs from each other. Each array of symbols is composed by combining symbols of “JACKPOT 7”, “BLUE 7”, “BELL”, “CHERRY”, “STRAWBERRY”, “PLUM”, “ORANGE”, and “APPLE”.

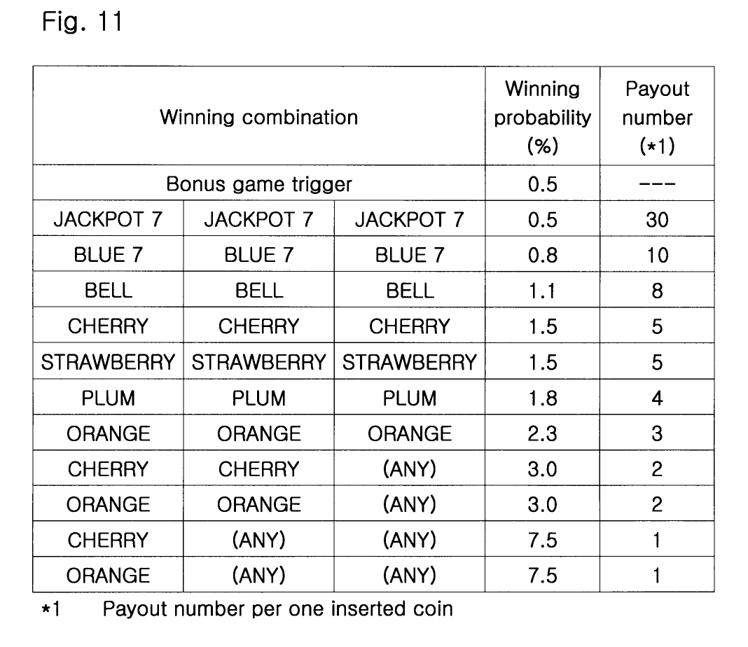

When three (3) symbols among “JACKPOT 7”, “BLUE 7”, “BELL”, “CHERRY”, “STRAWBERRY”, “PLUM”, and “ORANGE” are stopped and displayed along the pay line L, a predetermined number of credits are added as credits to be owned by the game player (refer to FIG. 11). Further, as for the symbols “CHERRY” and “ORANGE”, even if one or two symbols are stopped and displayed along the pay line, a predetermined number of credits are added as credits to be owned by the game player according to the number of these symbols (refer to FIG. 11).

The symbol “APPLE” is a free game trigger (a symbol for shifting to a free game). When three (3) symbols of “APPLE” are stopped and displayed along the pay line L, the game can shift to the free game. In the present embodiment, the free game refers to a bonus game (game which can be played over a predetermined number of times without betting coins).

When the spin button 23 is pressed and the game is started after the 1-BET button 26 or the MAX BET button 27 is pressed, the array of symbols drawn on each of the reels 14 is scrolled and displayed downward in each of the display windows 15 as each of the reels 14 is rotated. The symbols are stopped and displayed statically in the display windows 15 as the reels 14 stop their rotations after a predetermined period of time elapses. Various kinds of winning combinations (refer to FIG. 11) are defined in advance based on respective combinations of symbols. Then, when a combination of symbols corresponding to a winning combination stops along the pay line L, the corresponding number of coins to be paid out to the winning combination are added as the credits owned by the game player. When the free game trigger is realized, the free game starts.

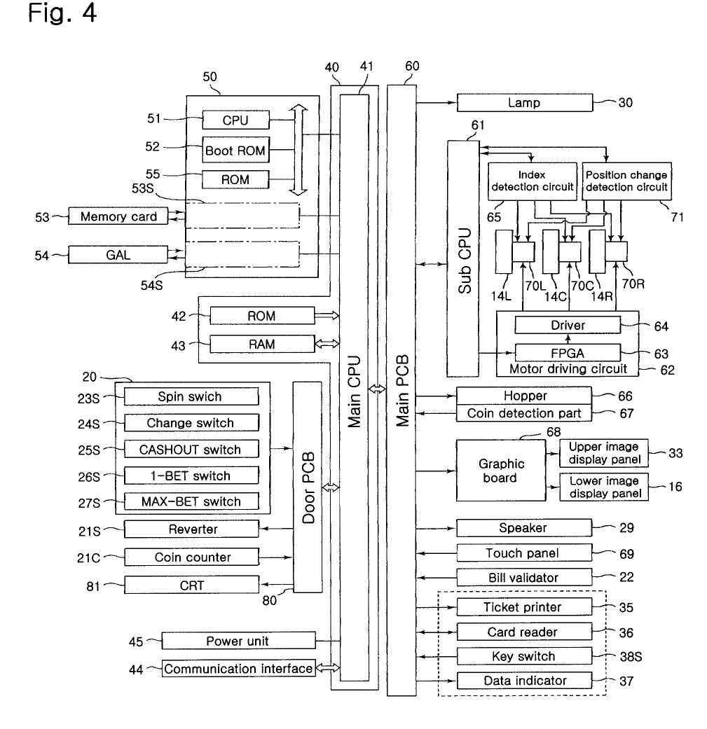

FIG. 4 is a block diagram showing an internal configuration of the gaming machine as shown in FIG. 2. A gaming board 50 comprises a CPU (Central Processing Unit) 51, a ROM 55 and a boot ROM 52, a card slot 53S for a memory card 53, and an IC socket 54S for a GAL (Generic Array Logic) 54 which are connected with each other by an internal bus.

The memory card 53 comprises a non-volatile memory such as Compact Flash (registered trademark) and stores a game program. The game program includes a lottery program. The lottery program is a program for determining symbols (respective code numbers corresponding to the symbols) of each reel 14 to be stopped and displayed statically along the pay line L.

The card slot 53S is formed so that the memory card 53 can be inserted and extracted, and connected to a mother board 40 by an IDE bus. Therefore, the kind and contents of the game played with the gaming machine 10 can be changed by extracting the memory card 53 from the card slot 53S, writing another game program in the memory card 53, and inserting the memory card 53 into the card slot 53S. The game program includes a program related to the game progress and a program related to the selection of the free games. The game program also includes image data and sound data which are output during the game.

The CPU 51, the ROM 55, and the boot ROM 52 which are connected with each other by the internal bus are connected to the mother board 40 by a PCI bus. The PCI bus performs signal transfer between the mother board 40 and the gaming board 50 and supplies electric power from the mother board 40 to the gaming board 50.

The mother board 40 is formed using a commercially available general-purpose mother board (a printed wiring board mounted with basic components of a computer), and provided with a ROM (Read Only Memory) 42, a RAM (Random Access Memory) 43, and a communication interface 44. The main CPU 41 is a processing unit in the present invention.

The ROM 42 comprises a memory device such as a flash memory and stores programs such as BIOS (Basic Input/Output System) executed by the main CPU 41 and permanent data. When the main CPU 41 executes the BIOS, the initialization process of prescribed peripheral devices is performed. Then, the loading process of the game program stored in the memory card 53 via the gaming board 50 is started. Here, in the present invention, the ROM 42 may be either rewritable or nonrewritable.

The RAM 43 stores data and a program used when the main CPU 41 operates. The RAM 43 can also store the game program.

Further, the RAM 43 stores data about the amount of credits, the number of inserted coins, and the number of payouts in one game, and the like.

The communication interface 44 is provided for performing communication with the management server 200 via the communication line 101. When the game start input is entered, the main CPU 41 receives data for the free game selection from the management server 200. The data for the free game selection to be described later in detail is data for selecting one kind of free game out of a plurality of kinds of free games, and is data for displaying an image for selecting the free game on the lower image display panel 16. Based on the received data for the free game selection, and instruction input for selecting one kind of free game, the main CPU 41 determines the number of times for the game player to play the game in the selected free game, and a multiplication factor at the time of winning the one kind of free game.

A body PCB (Printed Circuit Board) 60 and a door PCB 80 which are to be described later are connected to the mother board 40 by USBs, respectively. Further, a power supply unit 45 is connected to the mother board 40.

Instruments and devices for generating input signals to be input into the main CPU 41 and instruments and devices whose operations are controlled by control signals output by the main CPU 41 are connected to the body PCB 60 and the door PCB 80. The main CPU 41 executes the game program stored in the RAM 43 based on the input signals input into the main CPU 41, thereby performing a predetermined arithmetic process to store the results in the RAM 43, and transmitting a control signal to each of the instruments and devices as a control process for each instrument and device.

A lamp 30, a sub CPU 61, a hopper 66, a coin detector 67, a graphic board 68, the speaker 29, the touch panel 69, the bill validator 22, the ticket printer 35, the card reader 36, a key switch 38S, and the data indicator 37 are connected to the body PCB 60. The lamp 30 is turned on in a predetermined pattern based on the control signal output by the main CPU 41.

The sub CPU 61 controls the rotation and stop of the reel 14 (14L, 14C and 14R). A motor driving circuit 62 provided with an FPGA (Field Programmable Gate Array) 63 and a driver 64 is connected to the sub CPU 61. The FPGA 63 is an electronic circuit such as a programmable LSI and functions as a control circuit for a stepping motor 70. The driver 64 functions as an amplifying circuit for pulses input into the stepping motor 70. The stepping motor 70 (70L, 70C, and 70R) for rotating each reel 14 is connected to the motor driving circuit 62. The stepping motor 70 is a 1-2 phase excitation type stepping motor.

An index detection circuit 65 and a position change detection circuit 71 are connected to the sub CPU 61. The index detection circuit 65 detects the position of the reel 14 (an index to be described later) during rotation and can further detect the loss of synchronism of the reel 14.

The position change detection circuit 71 detects a change in the stopping position of the reel 14 after the rotation of the reel 14 is stopped. For example, the position change detection circuit 71 detects a change in the stopping position of the reel 14 when the stopping position is changed so as to forcibly obtain a winning combination of symbols according to the game player's operation although the combination of symbols is actually not the winning combination. The position change detection circuit 71 is configured to be able to detect the change in the stopping position of the reel 14 by, for example, detecting fins attached to the inner part of the reel 14 at prescribed intervals (not illustrated).

The hopper 66 is placed in the cabinet 11 and pays out a predetermined number of coins from the coin payout opening 19 to the coin tray 18 based on the control signal output by the main CPU 41. The coin detector 67 is provided inside the coin payout opening 19 and outputs an input signal to the main CPU 41 when the predetermined number of coins paid out from the coin payout opening 19 is detected.

The graphic board 68 controls image display in the upper image display panel 33 and the lower image display panel 16 as an output device based on the control signal output by the main CPU 41. The amount (or number) of credits stored in the RAM 43 is displayed on the credit number display part 31 of the lower image display panel 16. The number of coins for payout is displayed on the payout number display part 31 of the lower image display panel 16.

The graphic board 68 is provided with a VDP (Video Display Processor) for generating image data based on the control signal output by the main CPU 41, a video RAM for temporarily storing the image data generated by the VDP, and the like. Image data that the VDP generates is contained in the game program read from the memory card 53 and stored in the RAM 43.

The bill validator 22 checks the suitability of the bill and receives only authentic bills in the cabinet 11. The bill validator 22 outputs an input signal to the main CPU 41 based on the sum of bills when the authentic bill is received. The main CPU 41 stores the number of credits corresponding to the sum of bill transmitted by this input signal in the RAM 43.

The ticket printer 35 prints on a ticket a bar code on which the data about the amount of credits, date and time, the identification number of the gaming machine 10, and the like that are stored in the RAM 43 is coded based on the control signal output by the main CPU 41 and dispenses the ticket with the bar code 39.

The card reader 36 reads data from the smart card and transmits the read data to the main CPU 41, or writes data to the smart card based on the control signal from the main CPU 41. The key switch 38S is provided to the keypad 38 and outputs a predetermined input signal to the main CPU 41 when the keypad 38 is operated by the game player. The data indicator 37 displays the data read by the card reader 36, and data input by the game player via the keypad 38 based on the control signal output by the main CPU 41.

The control panel 20, a reverter 21S, a coin counter 21C, and a cold cathode tube 81 are connected to the door PCB 80. A spin switch 23S corresponding to the spin button 23, a change switch 24S corresponding to the change button 24, a CASHOUT switch 25S corresponding to the CASHOUT button 25, a 1-BET switch 26S corresponding to the 1-BET button 26 and a MAX BET switch 27S corresponding to the MAX BET button 27 are provided on the control panel 20. Each of the switches 23S to 27S outputs an input signal to the main CPU 41 when the corresponding buttons 23 to 27 are operated by the game player.

The coin counter 21C is provided inside the coin receiving opening 21 and checks the suitability of coins inserted into the coin receiving opening 21 by the game player. Objects other than the authentic coins are discharged from the coin payout opening 19. The coin counter 21C outputs an input signal to the main CPU 41 when the authentic coin is detected.

The reverter 21S operates based on the control signal output by the main CPU 41 and distributes coins recognized as authentic coins by the coin counter 21C to a cashbox (not illustrated) or the hopper 66 installed in the gaming machine 10. Specifically, when the hopper 66 is filled with coins, the reverter 21S distributes the authentic coins to the cashbox. On the other hand, when the hopper 66 is not filled with coins, the authentic coins are distributed to the hopper 66. The cold cathode tube 81 functions as backlight placed in the rear side of the lower image display panel 16 and the upper image display panel 33, and is turned on based on the control signal output by the main CPU 41.

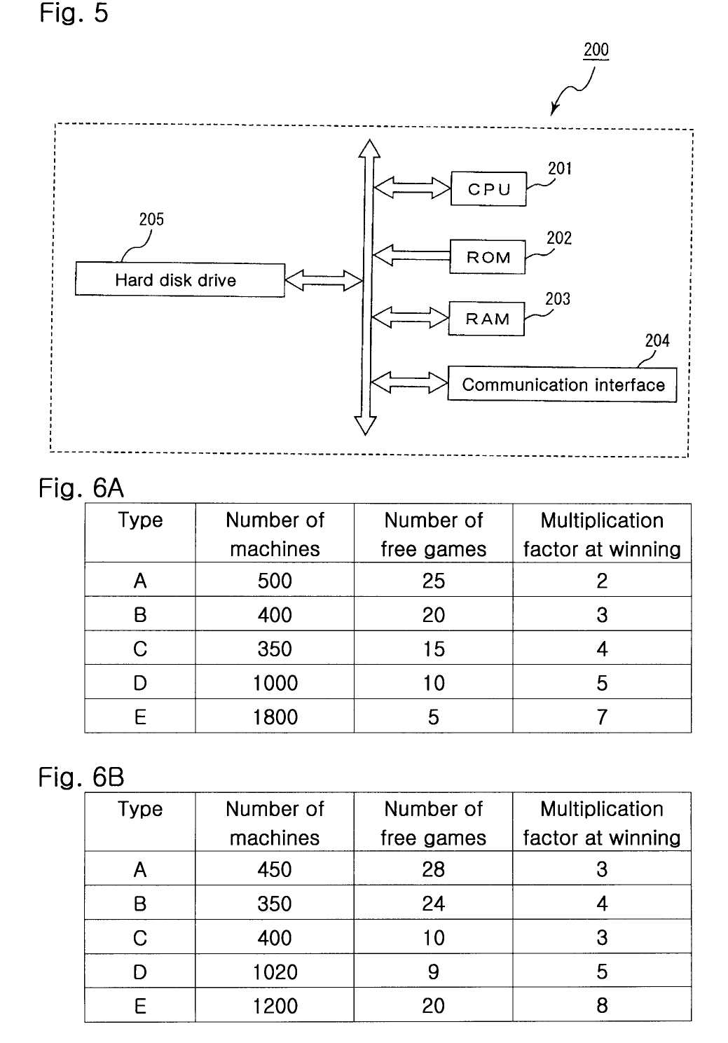

FIG. 5 is a block diagram showing an internal configuration of the management server according to an embodiment of the present invention.

The management server 200 is provided with a CPU 201 as a processing unit, a ROM 202, a RAM 203, a communication interface 204, and a hard disk drive 205. The communication interface 204 is connected to the communication interface 44 of each gaming machine 10 via the communication line 101. The ROM 202 stores a system program to control the operation of a control device, permanent data, and the like. The RAM 203 temporarily stores data received from each gaming machine 10 such as information concerning a kind of free game selected in each gaming machine 10, and data of the results of operations, and the like.

The CPU 201 calculates the number of free games to be played in each free game, and a multiplication factor at the time of winning each free game based on the information concerning the kind of free game received from each gaming machine 10, and stores them in the hard disk drive 205 as data for the free game selection. Specifically, the number of free games to be played in each free game, and the multiplication factor at the time of winning each free game are calculated as follows. A time interval to be calculated is not particularly limited. For example, the calculation may be performed for a predetermined period, or whenever the information concerning the kind of free game is received.

FIGS. 6A and 6B show data for a free game selection.

This embodiment includes five kinds of free games from A to E. FIG. 6A shows that five hundred (500) gaming machines 10 select the free game A, that the number of times for the free game A to be played (hereinafter also referred to as the number of free games) is 25, and that a multiplication factor at the time of winning the free game A is 2. Further, four hundred (400) gaming machines 10 select the free game B, the number of free games is 20, and a multiplication factor at the time of winning the free game B is 3. Three hundred and fifty (350) gaming machines 10 select the free game C, the number of free games is 15, and a multiplication factor at the time of winning the free game C is 4. One thousand (1000) gaming machines 10 select the free game D, the number of free games is 10, and a multiplication factor at the time of winning the free game D is 5. One thousand eight hundred (1800) gaming machines 10 select the free game E, the number of free games is 5, and a multiplication factor at the time of winning the free game E is 7.

In the present embodiment, the number of free games of the free game A is calculated by “150×(1−(number of machines)/1000)”. The number of free games of the free game B is calculated by “50×(1−(number of machines)×1.5/1000)”. The number of free games of the free game C is calculated by “50×(1−(number of machines)×2/1000)”. The number of free games of the free game D is calculated by “50×(1−(number of machines)×0.8/1000)”. The number of free games of the free game E is calculated by “50×(1−(number of machines)×0.5/1000)”.

Further, the multiplication factor at the time of winning the free game A is calculated by “10×(1−(number of machines)×1.6/1000)”. The rate at the time of winning the free game B is calculated by “10×(1−(number of machines)×1.75/1000)”. The multiplication factor at the time of winning the free game C is calculated by “10×(1−(number of machines)×1.8/1000)”. The multiplication factor at the time of winning the free game D is calculated by “10×(1−(number of machines)×0.5/1000)”. The multiplication factor at the time of winning the free game E is calculated by “10×(1−(number of machines)×0.15/1000)”. In the above formulae, calculation results after the decimal point may be either rounded off or discarded.

In the calculation of the number of free games, when a calculation result becomes five or less, the number of free games are set to “5”, and when it becomes 50 or more, the number of free games are set to “50.” In the calculation of the multiplication factor at the time of winning the free game, the multiplication factor is set to “1” when a calculation result becomes 1 or less; and the multiplication factor is set to “10” when it becomes 10 or more. Thus, the methods of calculating the number of free games and the multiplication factor at the time of winning each free game are different, and therefore each free game can have a specific individual characteristic.

FIG. 6B shows a state after a predetermined period of time elapsing from a state as shown in FIG. 6A.

If compared with the time point of FIG. 6A, the number of gaming machines 10 selecting the free game A decreases by 50. The number of gaming machines 10 selecting the free game B decreases by 50. The number of gaming machines 10 selecting the free game C increased by 50. The number of gaming machines 10 selecting the free game D increased by 20. The number of gaming machines 10 selecting the free game E decreases by 600. As a result, the number of free games of each kind of free game and the multiplication factor at the time of winning the free game increase or decrease according to the above formulae.

Next, the process performed in the gaming machine 10 is described.

The main CPU 41 advances the game by reading and executing the program related to the selection of the free games, and the game program.

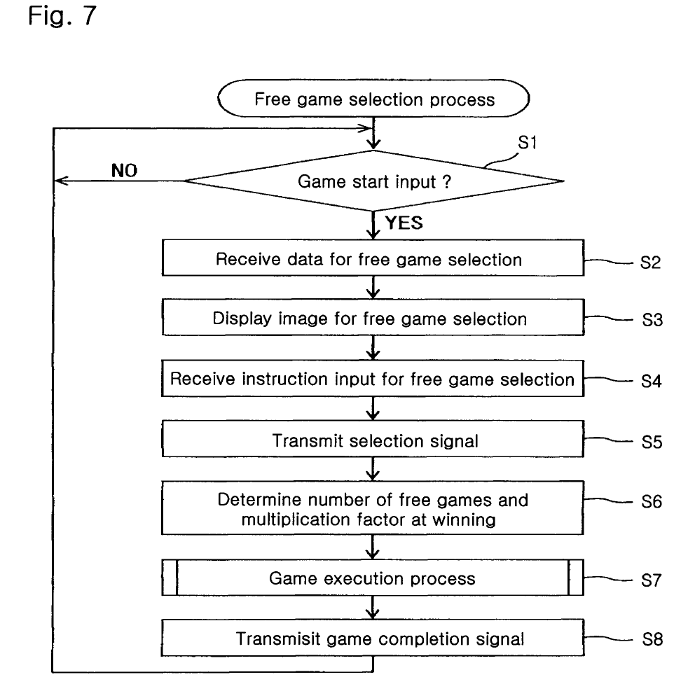

FIG. 7 illustrates a flowchart showing a subroutine of a free game selection process. If the main CPU 41 receives during the execution of the subroutine a detection signal output from the coin counter 21C when the coin counter 21C detects a coin inserted into the coin receiving opening 21, the main CPU 41 performs a process of addition to the number of credits stored in the RAM 43 as an interrupt process.

First, the main CPU 41 determines whether or not there is a game start input (step S1). In this process, the main CPU 41 determines whether or not a detection signal output from the coin counter 21C is received. That is, when it is determined that the detection signal output from the coin counter 21C is received, the main CPU 41 determines that there is the input for starting the game. The input for starting the game is not limited thereto, and, for example, the input may be performed via the touch panel 69. When it is determined that there is no input for starting the game, the processing is returned to the step S1. On the other hand, when it is determined that there is the input for starting the game, the process is shifted to the step S2.

In the step S2, the main CPU 41 transmits a demand signal to the management server 200 for demanding the transmission of the data for the free game selection, thereby receiving the data for the free game selection transmitted from the management server 200.

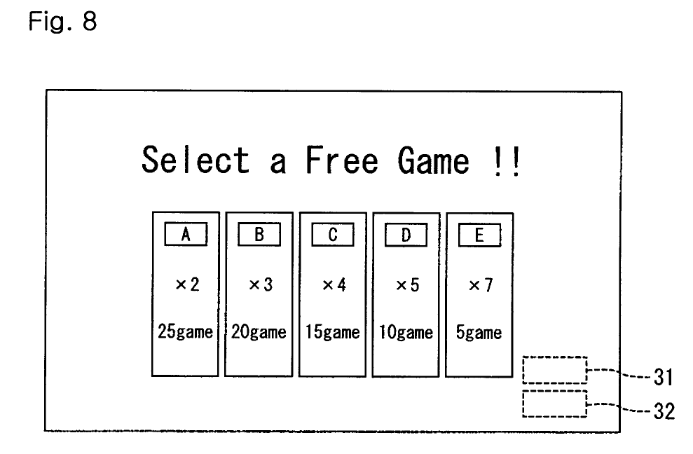

Next, in the step S3, the main CPU 41 causes the lower image display panel 16 to display images based on the received data for the free game selection. FIG. 8 shows the images displayed on the lower image display panel when the free game selection process is performed.

An image showing “Select a Free Game !!” is displayed on an upper part of the lower image display panel 16. This image is an image for urging the game player to select the free game. Images for the free game selection showing the kinds of free games (A to E), respective numbers of free games, and multiplication factors at the time of winning the respective free games are displayed on a central part of the lower image display panel 16. The game player can input an instruction to select one of the free games by touching a predetermined place of the touch panel 69 corresponding to a display area for one of the images for selection.

In the step S4, the main CPU 41 receives the selection instruction input of the free game. In this process, the main CPU 41 receives the selection instruction input based on a detection signal output from the touch panel 69. The touch panel 69 corresponds to the selection switch in the present invention. Next, in the step S5, the main CPU 41 transmits a selection signal including information concerning the selected kind of free game to the management server 200. Upon receiving this information, the management server 200 makes the addition to the number of gaming machines with which the same kind of free game is played. Then, the numbers of free games to be played in respective kinds of free games, and respective multiplication factors (or payout rates) at the time of winning the respective kinds of free games are calculated.

In the step S6, the main CPU 41 determines the data for the free game selection received in the step S2, the number of free games received based on the selection via the touch panel 69, and the payout rate at the time of winning the free game.

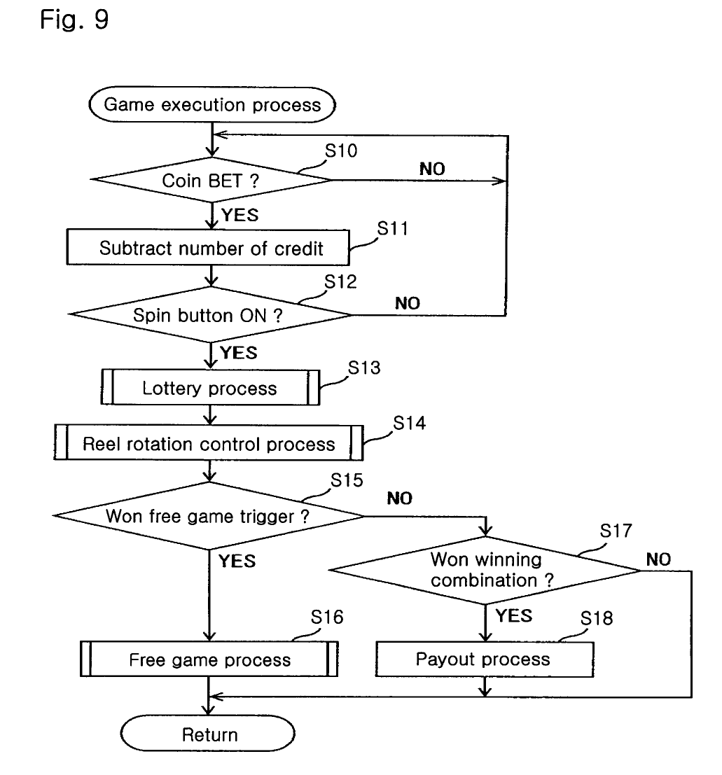

Next, in the step S7, the main CPU 41 performs the game execution process (step S7). Although this process is described later in detail in reference to FIG. 9, when the free game occurs during the game execution process, the free game proceeds based on the number of free games and the payout rate at the time of winning each kind of free game determined in the step S6.

Next, in the step S8, the main CPU 41 transmits a game completion signal to the management server 200. Upon receiving this information, the management server 200 subtracts the number of gaming machines in which the same kind of free game is played. Then, the number of free games to be played in each kind of free game, and the payout rate at the time of winning each kind of free game are calculated. The process is returned to the step S1 after this process.

FIG. 9 illustrates a flowchart showing a subroutine of the game execution process.

In the game execution process, the main CPU 41 determines first whether or not a coin is bet (step S10). In this process, the main CPU 41 determines whether or not an input signal output from the 1-BET switch 26S is received when the 1-BET button 26 is operated; or whether or not an input signal output from the maximum BET switch 27S is received when the maximum BET button 27 is operated. When it is determined that the coin is not bet, the process is returned to the step S10.

On the other hand, when it is determined that the coin is bet in the step S10, the main CPU 41 performs the process of subtracting a value corresponding to the number of bet coins from the number of credits stored in the RAM 43 (step S11). When the number of bet coins is greater than the number of credits stored in the RAM 43, the process is returned to the step S10 without performing the process of subtracting the value from the number of credits stored in the RAM 43. When the number of bet coins exceeds the upper limit which can be bet on one game (50 coins in the present embodiment), the process proceeds to the step S12 without performing the process of subtracting the value from the number of credits stored in the RAM 43.

Next, the main CPU 41 determines whether or not the spin button 23 is hit or turned on (step S12). In this process, the main CPU 41 determines whether or not it receives an input signal output from the spin switch 23S when the spin button 23 is hit or pressed. When it is determined that the spin button 23 is not turned on, the process is returned to the step S10. When the spin button 23 is not turned on (for example, when an instruction to terminate the game is input without turning on the spin button 23), the main CPU 41 cancels the subtraction result in the step S11.

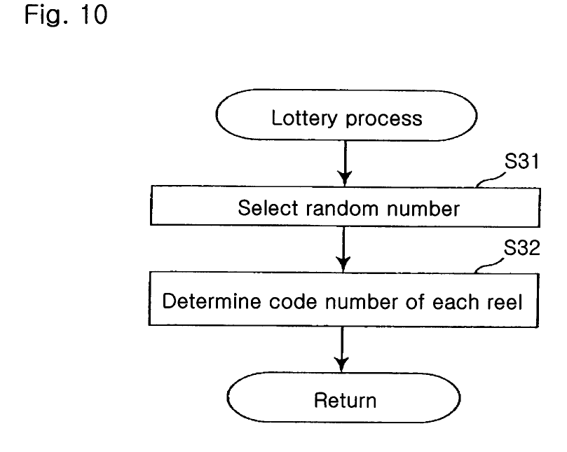

On the other hand, when it is determined that the spin button 23 is turned on in the step S12, the main CPU 41 performs a lottery process (step S13). In this lottery process, the main CPU 41 determines the code number of each reel 14 at the time of stopping as it executes the lottery program stored in the RAM 43. Thereby, a combination of symbols to be stopped and displayed is determined. This process is described later in detail in reference to FIGS. 10 and 11. In addition, in the present embodiment, a case is described in which one winning combination is determined from a plurality of kinds of winning combinations by determining a combination of symbols to be stopped and displayed. However, in the present invention, for example, one winning combination chosen first by the lottery from the plurality of kinds of winning combinations may be determined and subsequently each symbol of the combination of symbols to be actually stopped and displayed may be determined based on the winning combination.

Next, the main CPU 41 performs a rotation control process of the reels (step S14). This process is performed to stop the rotation of each reel after starting rotation of all reels 14 so that the combination of symbols corresponding to the winning combination determined in the step S13 is stopped and displayed along the pay line L.

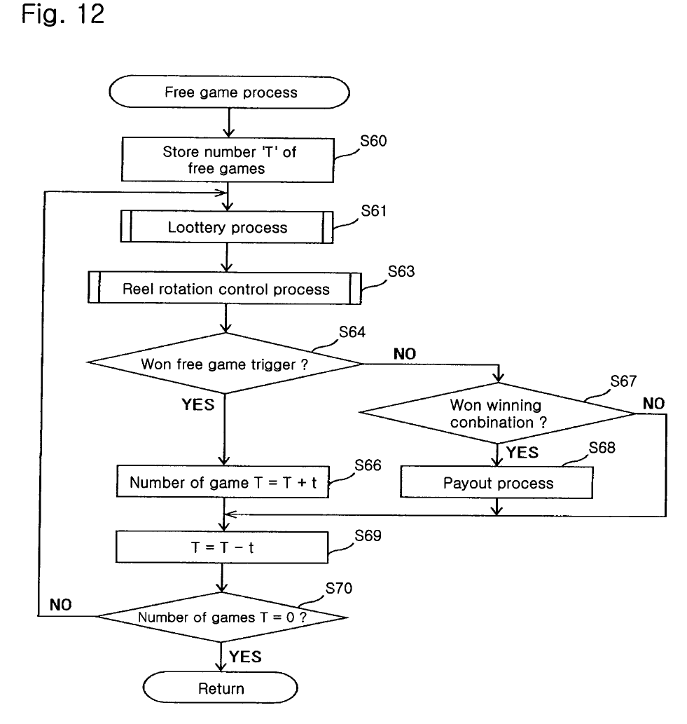

Next, the main CPU 41 determines whether or not the free game trigger is realized, that is, whether or not the symbol “APPLE” is stopped and displayed in the display window 15 (step S15). When it is determined that the free game trigger is realized, the main CPU 41 reads the program for performing the free game from the RAM 43, and performs a free game process (step S16). The free game process is described later in detail with reference to FIG. 12. The process is returned to the step S10 after the process of the step S16.

On the other hand, when it is determined that the free game trigger is not realized, the main CPU 41 determines whether or not the winning combination is realized (step S17). When it is determined that the winning combination is realized, the main CPU 41 pays out a number of coins corresponding to the number of inserted coins and the kind of the winning combination (step S18). When the number of paid out coins are stored, the main CPU 41 performs the process of addition to the number of credits stored in the RAM 43. On the other hand, in the case of paying out the obtained coins, the main CPU 41 transmits a control signal to the hopper 66 to pay out a predetermined number of coins. After the process of the step S18 is performed or after it is determined that none of the winning combinations is realized in the step S17 (when it is determined that the combination of symbols corresponds to one of the losing combinations), the process is returned to the step S10.

FIG. 10 illustrates a flowchart showing a subroutine of the lottery process that is called and executed in the step S13 of the subroutine shown in FIG. 9. This process is performed when the main CPU 41 executes the lottery program stored in the RAM 43. First, the main CPU 41 selects each random number value corresponding to each of the three reels 14 from a numeric value range of 0 to 255 by executing a program for random number generation included in the lottery program (step S31). In the present embodiment, a case where the random number is generated according to the program (a case where a so-called software random number is used) is described. However, in the present invention, a random number generator may be provided such that a random number is extracted from the random number generator (a so-called hardware random number is used).

Next, the main CPU 41 (central processing unit) determines the code number of each reel 14 (refer to FIG. 3) based on three selected random number values (step S32). The code number of each reel 14 corresponds to the code number of the symbol to be stopped and displayed along the pay line L. The main CPU 41 determines the winning combination by determining the code number of each reel 14. For example, when the code number of each reel 14 is determined to be “00”, “00”, and “00”, the main CPU 41 determines the winning combination to be “JACKPOT 7”.

Here, the winning combination in the present embodiment is described.

FIG. 11 shows a diagram for illustrating a relationship among the plurality of kinds of winning combinations, the winning probability of each of the winning combinations, and the number of payouts for each of the winning combinations according to the present embodiment. The winning probability of each of the winning combinations shown in FIG. 11 is derived from a case where the overall payout rate of the game excluding the free game is set to 88%. The winning probability shown in the diagram indicates a probability that the winning combination is realized when the code number of each reel 14 is determined based on three random number values with reference to symbol weighting data. That is, the random number value is not associated with each of the winning combinations.

The winning probability of the free game trigger is 0.5%. When the free game trigger is won, three symbols of “APPLE” are stopped and displayed along the pay line and the free game is started. In the free game, the free game is performed for the number of times determined by lottery.

The winning probability of “JACKPOT 7” is 0.5%. When this winning combination is realized, three symbols of “JACKPOT 7” are stopped and displayed along the pay line L, and thirty (30) coins per one inserted coin are paid out. The lower the winning probability of the winning combination is, the larger number of payouts is set. However, in a case where a combination of symbols corresponding to none of the winning combinations shown in FIG. 11 is stopped and displayed, the combination is the losing combination and no coin is paid out.

FIG. 12 illustrates a flowchart showing a subroutine of the free game process that is called and executed in the step S16 of the subroutine shown in FIG. 9. In the free game process, the number ‘T’ of free games determined in the step S6 of FIG. 7 is first stored in the RAM 43 in the step S60.

Next, the main CPU 41 performs the lottery process (step S61) and the reel rotation control process (step S63). The process of the step S61 is substantially the same as the process described with reference to FIG. 10. Since the process in FIG. 10 has already been described, a duplicated description here is omitted.

Next, the main CPU 41 determines whether or not the free game trigger is realized, that is, whether or not the symbol “APPLE” is stopped and displayed in the display window 15 (step S64). When it is determined that the free game trigger is realized, a repeat count ‘t’ of the free game is newly added (step S66). The repeat count ‘t’ may be equal to the number ‘T’ of free games determined in the step S6 of FIG. 7, or may be determined by lottery. As a result, when the free game is won during the free game, a remaining number of times of the free game increases. Specifically, when the game is shifted to the free game for the first time wherein twenty (20) free games are given and then the free game trigger is won again in the 12th free game, for example, the free game will be performed twenty eight (28) more times (20 times−12 times+20 times).

When the free game trigger is not realized, the main CPU 41 determines whether or not the winning combination is realized (step S67). When it is determined that the winning combination is realized, the main CPU 41 pays out coins corresponding to the number of inserted coins and the winning combination (step S68). Since this processing is similar to the processing of the step S18 and already described, the description is omitted here.

When the process of the step S66 or S68 is executed, or when it is determined that none of the winning combinations is realized (when it is determined that it is the losing combination) in the step S67, the main CPU 41 reads the game number ‘T’ of the free game stored in the RAM 43, and subtracts one (1) from the value of the read game number ‘T’. Then, the game number ‘T’ is again stored in the RAM 43 (step S69) after the subtraction.

Next, the main CPU 41 determines whether or not the number ‘T’ of free games having been performed reaches the number of free games determined in the step S60 (step S70). Specifically, it is determined whether or not the game number ‘T’ stored in the RAM 43 becomes 0. When the game number ‘T’ is not 0, that is, when it is determined that the number of free games having actually been performed does not reach the number of free games determined in the step S60, the process is returned to the step S61 and the above-described process is repeated. On the other hand, when the game number ‘T’ is 0, that is, when it is determined that the number of free games determined in the step S60 is reached, the CPU 41 terminates the present subroutine.

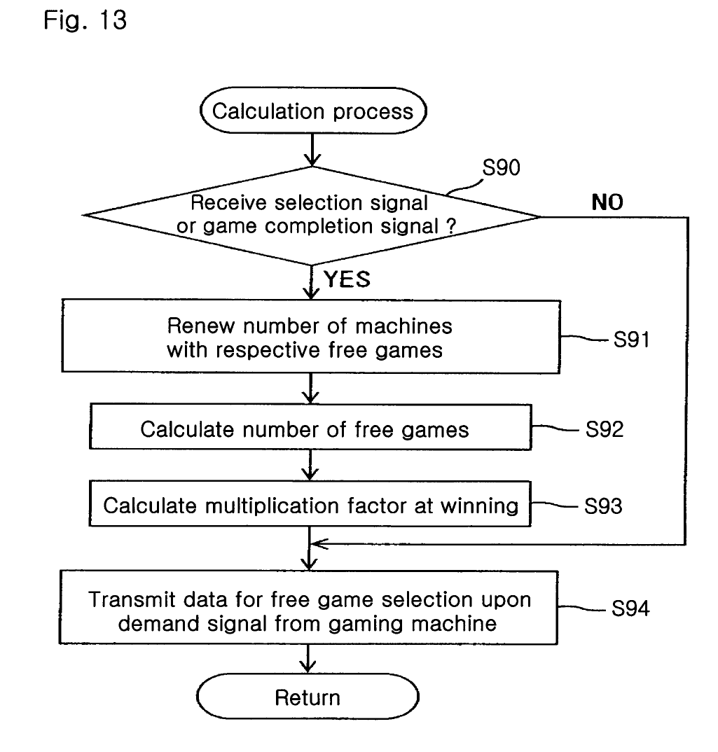

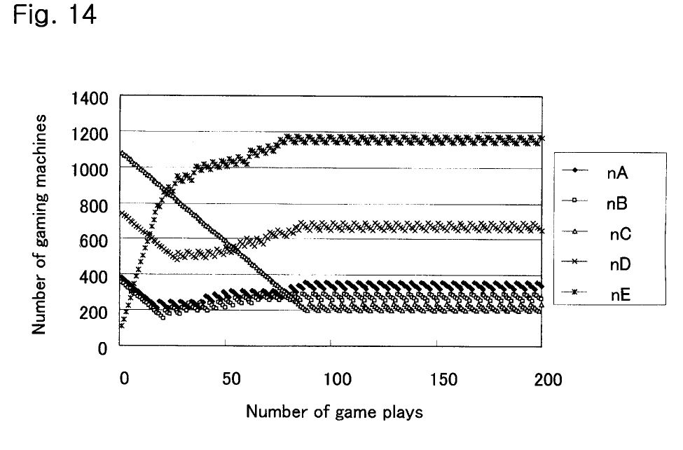

FIG. 13 illustrates a flowchart showing a subroutine of calculation process executed by the management server. First, the CPU 201 mounted in the management server 200 determines whether or not the selection signal or the game completion signal is received from the gaming machine 10 (step S90). When it is determined that the selection signal or the game completion signal is not received from the gaming machine 10, the CPU 201 shifts the processing to the step S94.

When it is determined that the selection signal or the game completion signal is received from the gaming machine 10 in the step S90, the CPU 201 updates the number of gaming machines 10 which currently select each kind of free game (step S91). Specifically, when the selection signal is received, the CPU 201 adds the number of gaming machines which select the same kind of free game based on the information concerning the free game contained in the selection signal. For example, when the received information concerning the free game is information concerning the free game A (information indicating that the free game A is selected), an addition process is made to the number of gaming machines which select the free game A. When it is determined that the game completion signal is received, the CPU 201 makes a subtraction from the number of gaming machines which select the free game.

Next, in the step S92, the CPU 201 calculates the number of free games in each free game in accordance with the number of gaming machines updated in the step S91 and a prescribed formula.

Next, in the step S93, the CPU 201 calculates a multiplication factor at the time of winning each free game in accordance with the number of gaming machines updated in the step S91 and a prescribed formula. Then, the data is stored as data for free game selection (refer to FIG. 6). The process is shifted to the step S94 after the process of the step S93.

In the step S94, when a demand signal is received from a gaming machine 10, the CPU 201 transmits the data for the free game selection to the gaming machine 10. The gaming machine 10 having received the data for the free game selection displays the image for free game selection (refer to the step S3 in FIG. 7), and accepts the selection of the free game (refer to the step S4 in FIG. 7). Then, the CPU 201 terminates the present subroutine.

As mentioned above, the gaming machine 10 according to the present embodiment comprises: the main CPU 41 (processing unit) and the touch panel 69 (selection switch) with which a game player can input an instruction to select one of the plurality of kinds of free games (special game) allowing the game player to play the game a predetermined number of times without making any bet. When the command signal for selecting one of the free games via the touch panel 69 is detected, the main CPU 41 executes the process of determining the number of free games to be played in the selected kind of free game, and the multiplication factor at the time of winning the selected free game according to the selection situation of the free games in other gaming machines 10 connected to the management server 200.

Further, the gaming system 100 according to the present embodiment comprises: the management server 200 and the plurality of gaming machines 10 which can perform the plurality of kinds of free games (special game) allowing respective game players to play the game for the predetermined number of times without making any bet. The management server 200 executes the process of receiving the selection signal including the information concerning the kind of free game selected in each gaming machine 10 out of the plurality of gaming machines 10. The management server 200 executes the process of calculating the number of gaming machines 10 which currently select each kind of free game based on the received selection signals. The management server 200 executes the process of calculating the number of free games to be played in each free game, and the multiplication factor at the time of winning each free game according to the number of gaming machines 10 which currently select each kind of free game. On the other hand, when one kind of free game is selected out of the plurality of kinds of free games, the gaming machine 10 executes the process of determining the number of free games to be played in the selected free game process and the multiplication factor at the time of winning the selected free game based on the calculated result of the management server 200.

Further, the game control method according to the present embodiment is utilized in the gaming machine 10 provided with the touch panel 69 (selection switch) with which the game player can input the instruction to select one of the plurality of kinds of free games (special game) allowing the player to play the free game for the predetermined number of times without making any bet. The game control method according to the present embodiment comprises a step of, when the command signal for selecting one of the free games via the touch panel 69 is detected, determining the number of free games to be played in the selected free game and the multiplication factor at the time of winning the free game according to the selection situations of the free games in other gaming machines 10 connected to the management server 200.

Further, the game control method according to the present embodiment is utilized in the gaming system 100 comprising: the management server 200 and the plurality of gaming machines 10 which can perform the plurality of kinds of free games (special games) allowing respective game players to play the game for the predetermined number of times without making any bet. The game control method according to the present embodiment comprises: a step of calculating the number of free games to be played in each kind of free game, and the multiplication factor at the time of winning each kind of free game according to the selection situation of the free games in the plurality of gaming machines 10. The game control method according to the present embodiment comprises: a step of, when one kind of free game is selected out of the plurality of kinds of free games, determining the number of free games to be played in the selected kind of free game and the multiplication factor at the time of winning the selected free game based on the calculated result of the management server 200.

Thus, according to the gaming machine 10, the gaming system 100 and the game control method according to the present embodiment, the number of free games to be played in each kind of free game and the multiplication factor at the time of winning each kind of free game can be changed according to the number of gaming machines 10 which currently select each kind of free game. Therefore, it is possible to provide the gaming machine 10, the gaming system 100, and the game control method 10 capable of securing entertainment features by preventing a selection bias when the game player is urged to select the special game out of the plurality of kinds, and preserving an individual character as one gaming machine 10.

Further, the gaming machine 10, the gaming system 100, and the game control method according to the present embodiment are described as follows.

When a command signal for selecting one of the plurality of kinds of free games from the touch panel 69 (selection switch) is detected, the gaming machine 10 executes the process of decreasing the number of free games to be played in the selected kind of free game as the number of other gaming machines 10 which select the selected kind of free game increases.

Thus, in the gaming machine 10, the gaming system 100, and the game control method according to the present embodiment, when the kind of free game selected in many other gaming machines 10 is selected, the number of free games in the selected kind of free game is reduced, and it becomes difficult to get many profits (coins). Therefore, a kind of free game to be selected by the game player increasingly tends to be directed to another kind of free game. As a result, the selection bias can be prevented more securely.

Further, the gaming machine 10, the gaming system 100, and the game control method according to the present embodiment are described as follows.

When a command signal for selecting one of the plurality of kinds of free games from the touch panel 69 (selection switch) is detected, the gaming machine 10 executes the process of reducing the multiplication factor at the time of winning the selected kind of free game as the number of other gaming machines 10 which select the selected kind of free game increases.

Thus, according to the gaming machine 10, the gaming system 100, and the game control method according to the present embodiment, when one kind of free game selected in many other gaming machines 10 is selected, a multiplication factor at the time of winning the selected kind of free game is reduced, and it becomes more difficult to get many profits (coins). Therefore, a kind of free game to be selected by the game player increasingly tends to be directed to another kind of free game. As a result, the selection bias can be prevented more securely.

Further, the gaming system 100 and the game control method according to the present embodiment are described as follows.

The management server 200 executes the process of receiving the information concerning the kind of free game selected by each of the plurality of gaming machines 10. The management server 200 executes the process of decreasing the number of free games of a kind in which the number selected by each of the plurality of gaming machines 10 increases.

Thus, in the gaming system 100 and the game control method according to the present embodiment, when a kind of free game selected in many other gaming machines 10 is selected, the number of free games in the selected kind of free game is reduced, and it becomes more difficult to get many profits. Therefore, the kind of free game to be selected by the game player increasingly tends to be directed to another kind of free game. As a result, the selection bias can be prevented more securely.

Further, the gaming system 100 and the game control method according to the present embodiment are described as follows.

The management server 200 executes the process of receiving the information concerning the kind of free game selected by each of the plurality of gaming machines 10. The management server 200 executes the process of decreasing the multiplication factor at the time of winning the free game of the kind in which the number selected by each of the plurality of gaming machines 10 increases.

Thus, according to the gaming system 100 and the game control method according to the present embodiment, when a free game selected in many other gaming machines 10 is selected, the payout rate at the time of winning the free game is reduced, and it becomes more difficult to get many profits. Therefore, a kind of free game to be selected by the game player increasingly tends to be directed to another kind of free game. As a result, the selection bias can be prevented more securely.

FIG. 14 illustrates a graph showing a simulation result of an example of the aforementioned embodiment. In the simulation, the following is assumed.
1) Initial data of numbers (nA, nB, nC, nD, and nE) of gaming machines are given from 0 to 1800 at random.
2) The number of free games is multiplied by the value of multiplication factor for each kind of the free games (A, B, C, D, and E) such that the product is utilized to evaluate the preference of the game player.
3) For each game play, all game players select one of the four kinds of free games.
4) Four kinds are evaluated by the products and one of the four kinds having the highest product is ranked No. 1.
5) In the next game play, forty (40) more game players select the kind having been ranked No. 1 in the previous game play such that ten (10) less game players select the other four kinds, respectively. Thus, the total number of game players remain the same.
6) The above 5th step is repeated over and over again.

As shown in FIG. 14, the number of gaming machines selecting each kind of free game converges on each specific value. For example, the number of gaming machines selecting the free game A converges on about 300 while the number of gaming machines selecting the free game E converges on about 1200. Each converging value may be determined by each coefficient of the number of gaming machines in the formulae. For example, in the free game A, the coefficient for the number of free games is one (1) and the coefficient for the multiplication factor is 1.6. The converging number of gaming machines of lower coefficients may be relatively higher. Therefore, it is possible to design each kind of free game so as to provide the individual characteristics.

As mentioned above, although the embodiments of the present invention are described, the embodiments just show specific examples, and do not limit the present invention in particular. Modification and alteration in the specific configuration of each means and the like can be suitably made within the scope of the present invention. Effects described in the embodiments of the present invention only enumerates the most suitable effects brought about by the present invention, and the effects according to the present invention are not limited to those described in the embodiments of the present invention.

As described above, various embodiments and modified embodiments are explained, and in addition the following may be included in the scope of the present invention.

A gaming machine according to the present invention comprises: a selection switch capable of entering an input for selecting one out of a plurality of kinds of special games to be played a predetermined number of times without making any bet; and a processor unit. The processor unit executes a determination process for determining a multiplication factor at a time of winning the one kind of special game and a number of special games to be played in the one kind of special game based on received data of a selection situation that the one kind of special game is selected in other gaming machines when an instruction signal to select the one special game is detected from the selection switch.

In the gaming machine according to the present invention, it is possible to change the multiplication factor at the time of winning the one kind of special game and the number of special games to be played in the one kind of special game according to a special game selection situation (e.g., a number of gaming machines in which each kind of special game is selected) in other gaming machines connected to a management server. Therefore, it is possible to prevent the selection bias when a game player is urged to select one of the plurality of kinds of special games and cause each gaming machine to have individual characteristics to secure the entertainment ability.

Also, the gaming system according to the present invention comprises a management server and a plurality of gaming machines in which a plurality of kinds of special games can be played a predetermined number of times without making any bet. The above management server executes a process for calculating a multiplication factor at a time of winning in each kind of special game and a number of special games to be played in each kind of special game according to a selection situation of the special game in the above plurality of gaming machines. Each of the above plurality of gaming machines executes a process for determining the number of special games to be played in the one kind of special game and the multiplication factor at the time of winning the one kind of special game based on a calculation result of the management server.

In the gaming system according to the present invention, it is possible to change the number of special games to be played in the one kind of special game and the multiplication factor at the time of winning the one kind of special game in accordance with a selection situation (e.g., a number of gaming machines in which each kind of special game is selected) of the special games in other gaming machines connected to the management server. Therefore, it is possible to prevent the selection bias when a game player is urged to select one of the plurality of kinds of special games and cause each gaming machine to have individual characteristics to secure the entertainment ability.

Also, the game control method according to the present invention is a game controlling method to be conducted in the gaming machine comprising: a selection switch capable of entering an input for selecting one out of a plurality of kinds of special games to be played a predetermined number of times without making any bet. The game control method comprises a step of determining a multiplication factor at a time of winning the one kind of special game and a number of special games to be played in the one kind of special game in accordance with a selection situation of the special game in other gaming machines connected to the management server when an instruction signal to select the one special game is detected from the selection switch.

In the game control method according to the present invention, it is possible to change the number of special games to be played in the one kind of special game and the multiplication factor at the time of winning the one kind of special game in accordance with a selection situation (e.g., a number of gaming machines in which each kind of special game is selected) of the special games in other gaming machines connected to the management server. Therefore, it is possible to prevent the selection bias when a game player is urged to select one of the plurality of kinds of special games and cause each gaming machine to have individual characteristics to secure the entertainment ability.

Further, the gaming machine and the gaming system according to the present invention may provide the following. The above gaming machine executes a process for reducing the number of special games in the one kind of special game being selected when an instruction signal to select the one special game is detected from the selection switch as a number of gaming machines in which the one kind of special game is selected increases.

In the gaming machine and the gaming system according to the present invention, it becomes more likely that the game player selects another kind of special game than the one kind of special game since it would be harder for the game player to obtain more profits because the number of special games the player can play becomes smaller if the game player selects the one kind of special game selected in many other gaming machines. As a result, it is more securely possible to prevent the selection bias.

Further, the gaming machine and the gaming system according to the present invention may provide the following. The above gaming machine executes a process for reducing the multiplication factor at the time of winning the one kind of special game being selected when an instruction signal to select the one special game is detected from the selection switch as a number of gaming machines in which the one kind of special game is selected increases.

In the gaming machine and gaming system according to the present invention, it becomes more likely that the game player selects another kind of special game than the one kind of special game since it would be harder for the game player to obtain more profits because the multiplication factor at the time of winning the one kind of special game becomes smaller if the game player selects the one kind of special game selected in many other gaming machines. As a result, it is more securely possible to prevent the selection bias.

Further, the gaming system according to the present invention may provide the following. The above management server executes a process for receiving information of the kinds of special games to be selected in the plurality of gaming machines. The above management server executes a process for reducing the number of special games in the one kind of special game as a number of gaming machines in which the one kind of special game is selected increases.

In the gaming system according to the present invention, it becomes more likely that the game player selects another kind of special game than the one kind of special game since it would be harder for the game player to obtain more profits because the number of special games the player can play becomes smaller if the game player selects the one kind of special game selected in many other gaming machines. As a result, it is more securely possible to prevent the selection bias.

Further, the gaming system according to the present invention may provide the following. The above management server executes a process for receiving information of the kinds of special games to be selected in the plurality of gaming machines. The above management server executes a process for reducing the multiplication factor at the time of winning the one kind of special game as a number of gaming machines in which the one kind of special game is selected increases.

In the gaming system according to the present invention, it becomes more likely that the game player selects another kind of special game than the one kind of special game since it would be harder for the game player to obtain more profits because the multiplication factor at the time of winning the one kind of special game becomes smaller if the game player selects the one kind of special game selected in many other gaming machines. As a result, it is more securely possible to prevent the selection bias.

According to the present invention, it is possible to provide a gaming machine, a gaming system and a game control method capable of securing entertainment features by preventing the selection bias when the game player is caused to select a special game out of a plurality of kinds, and preserving individuality as one gaming machine.

What is claimed is:

1. A gaming machine comprising:
a selection switch capable of entering an input for selecting one out of a plurality of kinds of special games to be played a predetermined number of times without making any bet; and
a processor unit for executing a determination process for determining a multiplication factor at a time of winning the one kind of special game and a number of special games to be played in the one kind of special game based on received data of a selection situation that the one kind of special game is selected in other gaming machines when an instruction signal to select the one special game is detected from the selection switch.

2. The gaming machine according to claim 1 wherein the processor unit executes a process for reducing the number of special games to be played in the one kind of special game upon detection of an instruction signal to select the one kind of special game as a number of the other gaming machines with which the one kind of special game is selected.

3. The gaming machine according to claim 1 wherein the processor unit executes a process for reducing the multiplication factor at the time of winning the one kind of special game upon detection of an instruction signal to select the one kind of special game as a number of the other gaming machines with which the one kind of special game is selected.

4. A gaming system comprising: a management server and a plurality of gaming machines in which a plurality of kinds of special games can be played a predetermined number of times without making any bet,
wherein the management server executes a process for calculating a number of special games to be played in one kind of special game and a multiplication factor at a time of winning the one kind of special game, and
wherein each of the plurality of gaming machines executes a process for determining a number of special games to be played in the one kind of special game and a multiplication factor at a time of winning the one kind of special game based on a calculation result of the management server.

5. The gaming system according to claim 4, wherein the management server executes a process for receiving information of the kinds of special games to be selected in the plurality of gaming machines and a process for reducing the number of special games in the one kind of special game as a number of gaming machines in which the one kind of special game is selected increases.

6. The gaming system according to claim 4, wherein the management server executes a process for receiving information of the kinds of special games to be selected in the plurality of gaming machines and a process for reducing the multiplication factor at the time of winning the one kind of special game as a number of gaming machines in which the one kind of special game is selected increases.

7. A game controlling method being conducted in a gaming machine in which a plurality of kinds of special games can be played a predetermined number of times without making any bet, the game control method comprising a step of:
determining a number of special games to be played in one of the plurality of kinds of special games and a multiplication factor at a time of winning the one kind of special game depending on a selection condition of the one kind of special game to be played in other gaming machines upon selection of the one special game out of the plurality of kinds of special games.

8. The game control method according to claim 7 wherein the step of determining comprises a step of reducing the number of special games to be played in the one kind of the special game as a number of other gaming machines in which the one kind of special game is selected increases.

9. The game control method according to claim 7 wherein the step of determining comprises a step of reducing the multiplication factor at a time of winning the one kind of special game as a number of other gaming machines in which the one kind of special game is selected increases.
